(19) United States
(12) Patent Application Publication
(10) Pub. No.: US 2006/0117732 A1
(43) Pub. Date: Jun. 8, 2006

(54) Vehicle for supporting a harvesting attachment with protective equipment for covering and/or illumination of the harvesting attachment

(76) Inventors: Richard Wubbels, Rhede (DE); Thomas Lukas, Ahaus-Wullen (DE)

Correspondence Address: DEERE & COMPANY, ONE JOHN DEERE PLACE, MOLINE, IL, 61265, US

(21) Appl. No.: 11/294,807

(22) Filed: Dec. 6, 2005

(30) Foreign Application Priority Data
Dec. 7, 2004 (DE) 10 2004 059 052.4

(51) Int. Cl. A01D 34/03

(52) U.S. Cl. 56/14.7

(57) ABSTRACT

A vehicle for the support of a harvesting attachment during over-the-road transportation. The vehicle features a frame and at least one wheel extending downward from the frame. The vehicle supports the harvesting attachment to reduce the load on the front wheels of a self-propelled harvester during on road transit and is detachable from the harvesting attachment when harvesting a field. Furthermore, protective equipment is installed on the vehicle for covering and/or illuminating the harvesting attachment during over-the-road transportation.

### BACKGROUND OF THE INVENTION

1. Field of the Invention

The present invention generally relates to agricultural machinery for the harvesting of fields. More specifically, the invention relates to a removable support vehicle for a harvesting attachment used on a self-propelled harvester.

2. Description of Related Art

On self-propelled harvesters, harvesting attachments are used for the harvesting and gathering of a crop. Recently, harvesters have become larger and the associated harvesting attachments are correspondingly wider and more massive. While some attachments, such as sickle sets for combines, are rigid and must be detached from the combine and put on a transport vehicle for over-the-road transportation, corn pickers and corn huskers for pick-up choppers are usually produced in a flip-up design. In such a configuration, the exterior side parts of the harvesting attachments are raised into a transport position, usually upward or towards the inside. This allows the attachments to remain coupled to the front end of the harvester during transport. However, the additional weight of the attachment often means the loading on the front wheels of the harvester may exceed the legal limit.

In U.S. Pat. No. 6,282,875 it was proposed to provide an additional wheel for the support of the harvesting attachment that can be dropped to the ground during over-the-road transportation of the harvester. This provides supplemental support to enable compliance with weight regulations. In one design the additional wheel is mounted on a separate vehicle which can be slid under and attached to the harvesting attachment.

Furthermore, if a harvester with a mounted harvesting attachment is to be driven on a public road, protective devices are also required to meet safety regulations in some countries. Typically, reflective warning signs must be mounted on the front and the side panels of the harvesting attachment. In addition, any raised side parts of the harvesting attachment need to be convered with lateral tarpaulins and light fixtures must also be mounted.

In the state of the art, and as shown in the drawing in U.S. Pat. No. 6,282,875, such protective equipment is individually fastened in a detachable manner to the harvesting attachment. Thus, in addition to mounting the vehicle to the harvesting attachment, the operator of the harvester must also separately install the protective equipment, which must then be taken down before the next harvesting operation. The total time required to complete all of these operations is quite extensive.

In view of the above, it is apparent that there exists a need to reduce the time required to prepare a self-propelled harvester with a harvesting attachment for over-the-road transport. An objective of this invention is therefore to allow an operator to prepare a self-propelled harvester for over-the-road transport, wherein the weight of the harvesting attachment is supported and all necessary safety equipment is provided, through the attachment of a single vehicle.

### BRIEF SUMMARY OF THE INVENTION

In satisfying the above need, as well as overcoming the enumerated drawbacks and other limitations of the related art, the present invention discloses a vehicle for the support of the harvesting attachment for over-the-road transport which allows a shortening of the change-over time between a road transport configuration and a harvesting configuration.

More specifically, the invention concerns a detachable vehicle for the support of a harvesting attachment, wherein the vehicle features a mounting frame and at least one wheel extending downward from the frame. In addition, the protective equipment for the harvesting attachment, which usually includes warning signs, lateral tarpaulin's and headlights, is also mounted on the frame. Thus, it is possible to comply with safety regulations during over-the-road transport, without requiring the operator to spend considerable time installing a support vehicle and protective equipment. Also, since the protective equipment is attached to the vehicle, it cannot get lost or be forgotten.

Concerning the protective equipment, the warning signs are installed on a support beam running horizontally and perpendicular to the direction of travel near the front of the vehicle. The signs typically hang vertically and are mounted perpendicular to the front of the harvesting attachment. To increase visibility, they are reflecting and patterned.

In addition, the support beam may be used for fastening a vertical retaining post to support the lateral tarpaulin's. Each lateral tarpaulin covers one side of the harvesting attachment during road transport. Thus, during installation of the vehicle, the tail end of the tarpaulin is pulled tight and fastened to the back side of the harvesting attachment. A bar equipped with spring-loaded hooks may also be attached the tail end of the tarpaulin to facilitate fastening the tarpaulin to the harvesting attachment and allow tightening of the tarpaulins. Alternatively, the lateral tarpaulins and retaining posts may be replaced by rigid side walls fixed to the frame. This configuration removes the need to manually install and remove the tail ends of the tarpaulins from the harvesting attachment but at the expense of increased weight.

Next, the protective equipment also includes headlights consisting of white lamps and/or flashing amber lights. The light fixtures are typically mounted to the support beam, near the warning signs. A power cable for the lights can also be fastened along a lateral tarpaulin. A plug is provided at the rear end of the cable which can be inserted into a complementary socket on the harvester.

If upon completion of the harvesting process, the harvester finds itself a considerable distance from the vehicle, which is usually parked at the edge of the field, it may be beneficial to transport the vehicle to the harvester. However, due to the support beam and the protective elements attached to the frame of the vehicle, the entire vehicle is relatively bulky. Therefore, transporting the vehicle, for instance on a trailer or by tractor, is simplified if the support beam can be collapsed into a more compact form. This can be achieved by forming the beam of three elements, the middle of which is fixed to the frame. The two outer elements can pivot around vertical hinges, which serve to attach them to the middle element, and can be locked in position. For compact transport of the vehicle, the outer elements are pivoted around the vertical axes, usually towards the rear. Another possibility for a collapsible support beam would use two elements. Each element defines one half of the beam and is attached directly to the frame with lockable, pivoting joints.

Finally, since tractors are usually involved with agricultural harvests, it is advantageous to use a tractor to transport the vehicle, saving the time normally spent loading the vehicle onto a trailer. This configuration requires the frame to feature fasteners which can be connected to the three-point-hitch, or other suitable interface, of the tractor. The tractor is then driven to the parking location of the vehicle, the three-point-hitch or other interface is connected to the frame, and the tractor tows the vehicle to the location of the harvester.

These and other aspects and advantages of the present invention will become apparent upon reading the following detailed description of the invention in combination with the accompanying drawings.

### BRIEF DESCRIPTION OF THE DRAWINGS

The drawings show a design example of the invention which is described in more detail below:

FIG. 1 is a side view of the front of the intake housing of a harvester with a harvesting attachment and a support vehicle, with the protective equipment omitted;

FIG. 2 is a view similar to that of FIG. 1, but with the protective equipment included and showing the front part of the harvester;

FIG. 3 is a side view of the support vehicle separated from the harvesting attachment;

FIG. 4 is a front view of the support vehicle separated from the harvesting attachment;

FIG. 5 is a top view of the support vehicle coupled to the harvesting attachment; and

FIG. 6 is a side view of a tractor with the support vehicle attached to the tractor's lower hitch points.

### DETAILED DESCRIPTION OF THE INVENTION

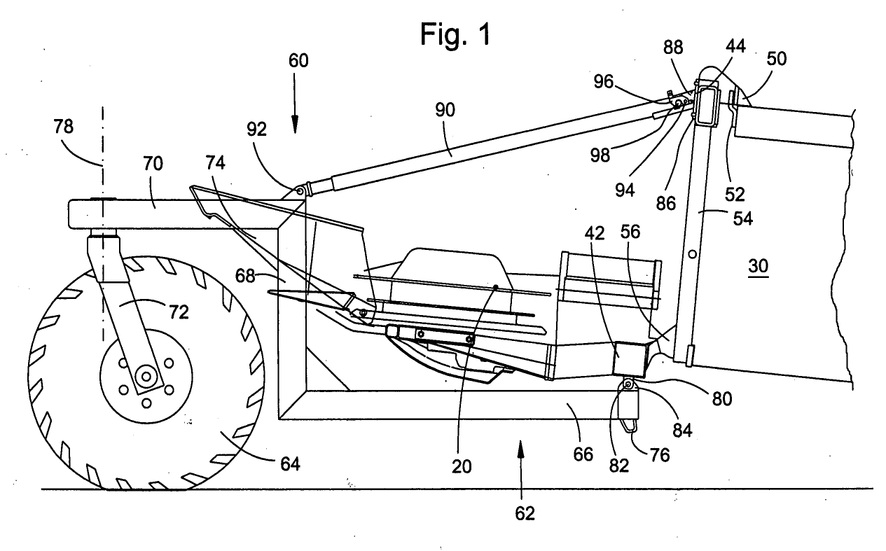

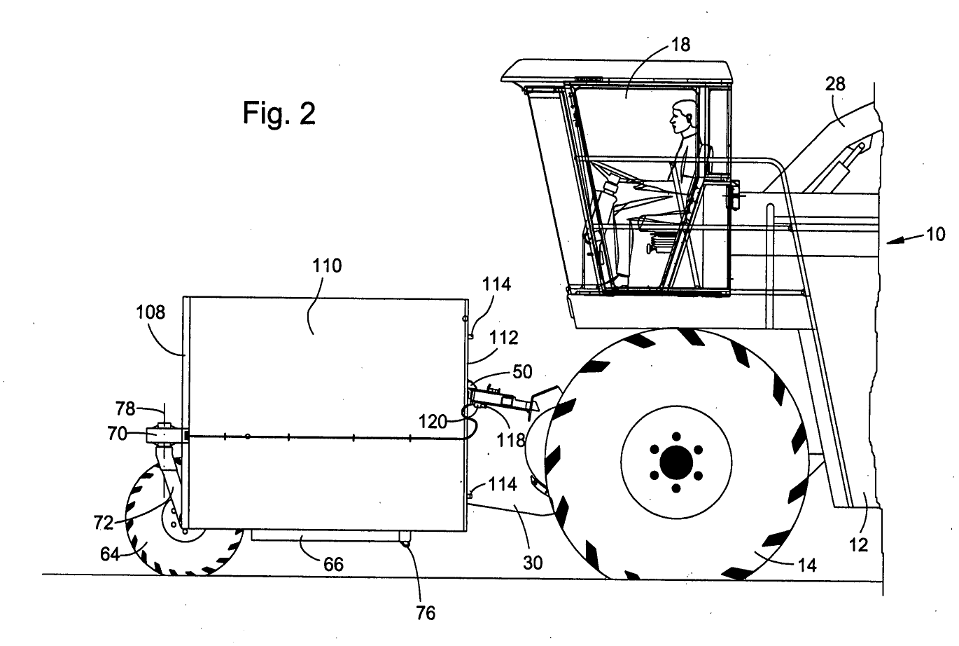

FIG. 1 shows the intake housing 30 of an agricultural harvester 10 (see FIG. 2) represented in the form of a self-propelled field chopper. The harvester 10 is built on a chassis 12 which is supported by driven front wheels 14 and steerable rear wheels (not shown). Operation of the harvester 10 is carried out from an operator cabin 18 from which a harvesting attachment 20 is visible. Material, e.g. corn, picked up from the ground by means of the attachment 20 is transported via an intake housing 30 of a chopper drum (not shown) to the interior of the harvester 10 which chops the corn into small pieces and delivers it to a conveyor device (also not shown). The material exits the harvester 10 via a rotatable extractor shoot 28 to a container vehicle following the harvester on its side. A regrinder (not shown) may be located between the chopper drum and the conveyor. Although the invention is shown on a field chopper, it may also be used with any other self-propelled harvesters, such as combines and their associated harvesting attachments.

Indications of direction used in the following description, such as in front of, behind, to the side of and above, are in relation to the forward motion of the harvester 10, which is to the left in FIGS. 1 and 2. For example, pick-up of the crop to be harvested is performed by the harvesting attachment 20, fastened to the front end of the intake housing 30 of the harvester 10.

Referring now to the embodiment shown in FIG. 5, the harvesting attachment 20 is a corn header known in the art. Instead of the rigid corn header shown, which cannot be pivoted into an over-the-road position with reduced width, another version featuring outer parts fastened to a middle section and folded upward for over-the-road transportation could also be used. In the present design four intake and reaper drums 32 are mounted to the harvesting attachment 20. During operation, the intake and reaper drums 32 pull in the stems of the crop material in a vertical position, cut them off and transport them to the intake housing 30 and then to the chopper drum of the harvester 10.

Returning to FIG. 1, the harvesting attachment 20 includes a carrier frame which features a lower crossbeam 42 and an upper crossbeam 44. The lower crossbeam 42 lies below and on the back side of the harvesting attachment 20. The upper crossbeam 44 extends sideways above the inlet of the intake housing 30 over its entire width. The upper crossbeam 44 is connected with hook-shaped supporting members 50 to complementary supporting members 52 on the intake housing 30. It is also connected to the lower cross beam 42 by vertically extending beams 54 and connecting plates 56. In addition, the complementary supporting members 52 serve to fasten the harvesting attachment 20 to the harvester 10.

The harvesting attachment 20 also rests on a vehicle 60 which supports the harvesting attachment 20 during over-the-road transportation. The support vehicle 60 (hereafter just “vehicle”) is composed of a frame 62 and a wheel 64. The frame 62 includes a fan-shaped back piece 66 which is connected by, more or less, vertical braces 68 to a front part 70, and wheel mountings 72 located below the front part 70 for the wheel 14 which rotates around a wheel axis extending in the cross-direction. On the side of the front part 70 that faces the back piece 66 is a vehicle-positioning mechanism 74 featuring a pocket or bag-shaped opening (in FIG. 1 shown with an opening to the right) the underside of which extends backward and downward to the back piece 66. The vehicle-positioning mechanism 74 serves to automatically align the vehicle 60 with the harvesting attachment 20, by receiving in it a separator point 71 of the harvesting attachment 20 (see FIG. 5). Supports 76, located in the back, support the back piece 66 of the frame while on the ground. In the embodiment shown, the wheel 64 is linked to the frame 62 in a trailing and steerable fashion around the approximately vertical rotational axis 78.

Two brackets 80 welded to the underside of the lower crossbeam 42 are connected by detachable locking pins 82 with retainers 84 fastened to the outside of the rear upper side of the back piece 66. The locking pins 82 extend each through coaxial openings in the bracket 80 and in the retainer 84. Furthermore the upper cross beam 44 is enclosed by two side-by-side brackets 86 that are bolted to the crossbeam, each of which support one receiving mechanism 88. Two braces 90 are coupled at their front ends to a horizontal axis 92 in cross-direction to the forward movement, located on the upper surface of the rear end of the front piece 70 of the vehicle 60, and at their rear ends they rest on a receiving mechanism 88. A locking bar 96 coupled to the receiving mechanism 88 that swivels around a horizontal axis 94 in cross-direction to the forward movement, encloses from above a horizontal pin 98 in cross-direction to the forward movement which is fastened to the rear end of the brace 90.

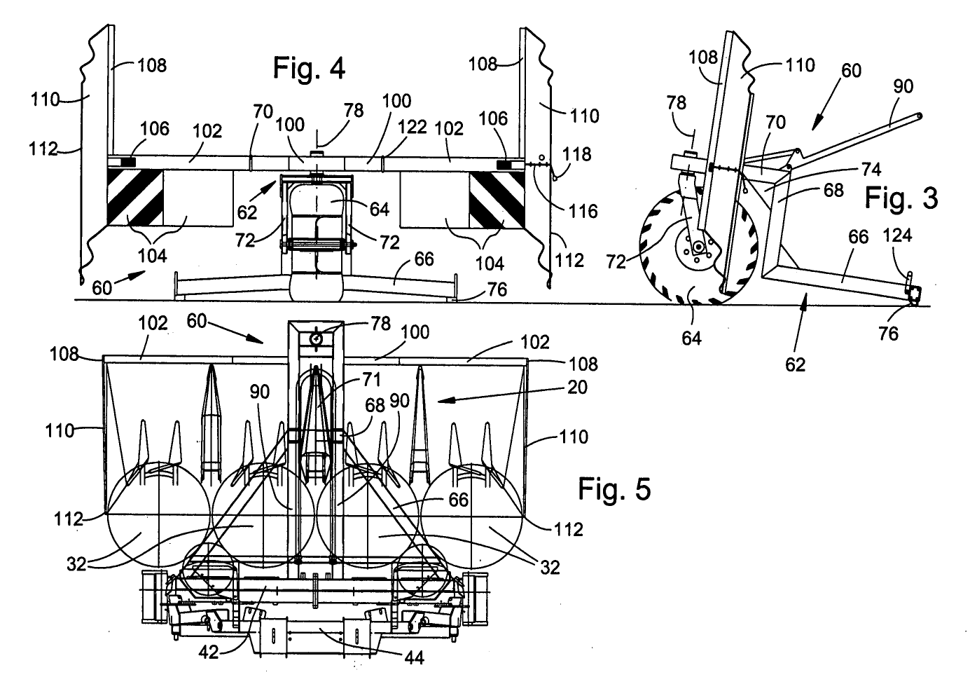

FIGS. 3 and 4 show the vehicle 60 without the harvesting attachment 20. Behind the rotational axis 78 a horizontal beam is installed on the front piece 70 in cross-direction to the forward movement and which comprises a middle element 100 that is rigidly fastened to the front piece 70 as well as two parallel outer elements 102. Vertical warning signs 104 are fastened in cross-direction to the forward movement on the undersides of the outer elements 102. On their ends the outer elements 102 also have lighting devices 106 in the form of combined amber flashing and white headlights.

On the outer ends of the outer elements 102 vertically extending support posts 108 are also mounted which hold a lateral tarpaulin 110 on each side. At the rear end of the lateral tarpaulin 110, bars are fastened that in turn are connected in a detachable manner by spring-loaded hooks 114 to the harvesting attachment 20. The bars 112 and the support posts 108 are preferably rectangular tubes. A connector cable 116 connected to the lighting devices 106 is fastened over a portion of its length to the left side tarpaulin 110, between two layers of the side tarpaulin 110, and has a plug 118 on its end which can be inserted into a suitable socket 120 at the intake housing 30 of the harvester 10.

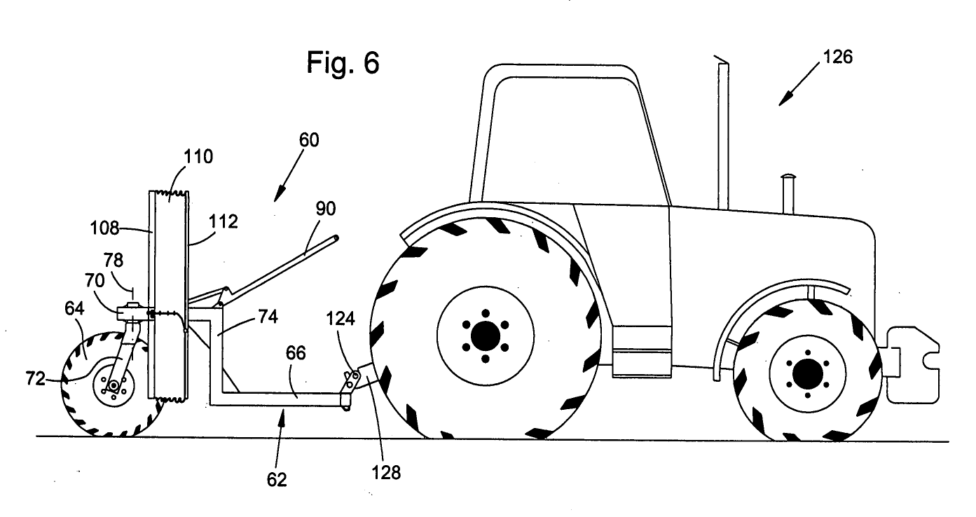

The outer elements 102 of the crossbeam are linked at vertically extending crossbeam axes 122 on the middle element 100 and can be locked in the position shown in FIGS. 2 to 5. The vehicle 60 features at its rear end 62 pivoting fasteners 124 for mounting the frame 62 to the lower hitch points 128 (FIG. 6) of the tractor 126. The brace 90 may then be connected to an upper hitch point of the tractor.

The configuration shown in FIGS. 1 and 2 is realized for transporting the harvester 10 with the harvesting attachment 20 over a roadway. The operator drives the harvester 10 with the harvesting attachment 20 up to the vehicle 60, so that the vehicle positioning device 74 effects, together with the separator point 71, the desired alignment between vehicle 60 and the harvesting attachment 20. The retention pins 82 are inserted and the brace 90 is locked into place.

To simplify the movement for attaching the vehicle 60 to the harvesting attachment 20 a single lever could be provided above the front piece 70. The lever would be coupled on the front piece of the vehicle 60 around a horizontal axis placed in the cross-direction to the forward movement. Above the horizontal axis two bars are coupled to the lever which are connected at their other end to an additional bracket which is fastened to a brace 90. In addition a cable is fastened to the underside of the braces that is connected via deflection pulleys to the spring-loaded retention pins 82 and serves to lock and unlock these. In this manner, it is possible to place the braces 90 on the receiving mechanism 88 through a movement of the lever and to close simultaneously the lower locking mechanism with the bolts 82. A movement of the lever 2 in the opposite direction can pivot the braces upward and release the bolts 82. Since the vehicle 60 is also provided with protective equipment composed of the warning signs 104, the lateral tarpaulins 110 and the lighting fixtures 106, only the hooks 114 of bars 112 on the backsides of the lateral tarpaulins 110 need to be fastened to the harvesting attachment 20 and the plug 118 inserted in the socket 120. Thus, additional measures for attaching the protective equipment becomes unnecessary.

When the vehicle 60 is to be separated from the harvesting attachment 20 during harvesting operations, the harvesting attachment 20 is raised by activating appropriate hydraulic cylinders of the harvester 10, to unload the wheel 64. Then the retention pins 82 are removed and the latch 96 is rotated to the back (clockwise in FIG. 4) to release the brace 90. Next, the spring-loaded hooks 114 are removed and the plug 118 is pulled out of the socket 120. Finally, the harvester 10 backs away from the vehicle 60. Thus, the change-over time for either road transport or harvesting operations is relatively short.

To avoid the need for the operator to leave the driver's cabin 18 for either fastening or removing the vehicle 60 from the harvesting attachment 20, power-operated retention devices may be provided, e.g. hydraulic cylinders which can be controlled from the driver's seat in the cabin 18. The latch 96 can also be moved or released by a powered actuator or a manual cable. The plug 118 can be fastened to the frame 62 while the socket 129 is affixed to an adjacent support of the intake housing 30, allowing the electrical connection for the light fixtures 106 to be automatically engaged or disengaged when the vehicle 60 is coupled or uncoupled. The lateral tarpaulins could then be replaced by rigid design or be seized and tensioned by an appropriate traction mechanism on the harvester 10.

If, upon completion of the harvesting operations, the vehicle 60 is located a considerable distance from the harvester 10, the vehicle 60 can be towed to the harvester 10 by a tractor 126 (FIG. 6) by connecting the lower hitch points 128 of the tractor to the fasteners 124. An alternate embodiment would also connect an upper hitch point of a three-point hitch to the brace 90. The width of the vehicle 60 can be significantly reduced for transportation by pivoting the outer elements 102 backward (to the right in FIG. 3) around the crossbeam axes 122.

The foregoing disclosure is the best mode devised by the inventor for practicing this invention. It is apparent, however, that methods incorporating modifications and variations will be obvious to one skilled in the art of agricultural machinery. Inasmuch as the foregoing disclosure is intended to enable one skilled in the pertinent art to practice the instant invention, it should not be construed to be limited thereby but should be construed to include such aforementioned obvious variations and be limited only by the spirit and scope of the following claims. I/We claim:

1. A vehicle for supporting a harvesting attachment during road use that reduces the load on the front wheels of a self-propelled harvester and that may also be removed from the harvester during the harvesting of a field, the vehicle comprising a mounting frame having front and rear ends, at least one wheel extending downward from the frame such that the frame is adapted to support the harvesting attachment, brackets located toward the rear end of the frame and configured to attach the vehicle to the harvesting attachment, and protective equipment for the harvesting attachment being mounted on the frame.

2. A vehicle according to claim 1, further comprising a crossbeam mounted horizontally on the frame toward the front end of the frame at a location to be in front of the harvesting attachment, and wherein the protective equipment is fastened to the crossbeam.

3. A vehicle according to claim 2, further comprising a vertical retaining post mounted on each end of the crossbeam, the protective equipment including at least one lateral tarpaulin connected at one end to one of the vertical retaining posts and extending laterally along the side of the vehicle, the tarpaulin at its rear end configured to be connected to the harvesting attachment.

4. A vehicle according to claim 3, wherein the tarpaulin is provided at its rear end with a bar provided with spring-loaded hooks that can be connected to the harvesting attachment and, when connected as such, serve to tension the tarpaulin.

5. A vehicle according to claim 1, wherein the protective equipment includes lighting fixtures on the front end of the frame.

6. A vehicle according to claim 5, further including a connecting cable to power the lighting fixtures with a plug for insertion into a complementary socket on the harvester, the cable for the lighting fixtures is attached to the lateral tarpaulin.

7. A vehicle according to claim 2, wherein the crossbeam is transformable into a compact transport position to facilitate separate transportation of the frame.

8. A vehicle according to claim 7, wherein the crossbeam comprises a center element and two outer elements, wherein the center element is rigidly fastened to a pivot in the frame allowing the crossbeam to pivot around an approximately vertically axis located at the middle of the center element.

9. A vehicle according to claim 1, further including mounts on the frame for installing the frame to an interface, in particular a three-point hitch of a tractor, to allow separate transportation of the vehicle by a tractor.

10. A vehicle according to claim 1, wherein the vehicle is attached to a harvesting attachment and the harvesting attachment is attached to a self-propelled harvester.

11. A vehicle according to claim 1, wherein the protective equipment includes warning signs.

12. A vehicle according to claim 1, wherein the protective equipment includes coverings to cover the harvesting arrachment.
